(19) United States
(12) Patent Application Publication
(10) Pub. No.: US 2017/0206502 A1
(43) Pub. Date: Jul. 20, 2017

(54) System, device, and method for online reputation development and customer service management

(71) Applicant: Global Marketing Resources, LLC, Tustin, CA (US)

(72) Inventor: Ajay K. Prasad, Tustin, CA (US)

(21) Appl. No.: 14/997,310

(22) Filed: Jan. 15, 2016

(51) Int. Cl. G06Q 10/10; G06Q 10/06

(52) U.S. Cl. CPC G06Q 10/105; G06Q 10/0633

(57) ABSTRACT

A system for online reputation development, including a reputation development server, including a processor, a non-transitory memory, an input/output component, a messaging manager, a data bus; a reputation development device; and optionally a customer relationship management system; and an electronic records management system; such that the reputation development server receives a customer review, including a service rating, such that the reputation development server executes an automated dialogue based on an optimal workflow with the customer, wherein the optimal workflow is selected based on the service rating. Also disclosed is a method for online reputation development, including receiving a rating, selecting an optimal workflow, and executing a customer dialogue.

### CROSS-REFERENCE TO RELATED APPLICATIONS

N/A

### FIELD OF THE INVENTION

The present invention relates generally to the field of customer service management, and more particularly to methods and systems for online reputation development.

### BACKGROUND OF THE INVENTION

With the increased proliferation of mobile devices with broadband access to internet based services, companies offering products and services to consumers must increasingly be aware of their online reputation, which is manifested as review ratings and comments from consumers.

There are consultants who for a fee will help a company maintain a high online reputation or improve an online reputation that has become lower than desirable.

However, such services often rely on manual social media interaction, and can be both expensive and time consuming.

As such, considering the foregoing, it may be appreciated that there continues to be a need for novel and improved devices and methods for managing and developing online reputation.

### SUMMARY OF THE INVENTION

The foregoing needs are met, to a great extent, by the present invention, wherein in aspects of this invention, enhancements are provided to the existing model of online reputation development.

In an aspect, a system for online reputation development, can include:
a) a reputation development server; and
b) a reputation development device;
such that the reputation development server can receive a customer review, including a service rating, which has been provided by a customer in relation to a service provided by a company;
such that the reputation development server can communicate with the reputation development device, which is used by the customer;
such that the reputation development server executes an automated dialogue with the customer, via the at least one reputation development device, wherein the automated dialogue is selected based on the service rating;
whereby an online reputation of the company client can be developed.

In a related aspect, the reputation development server can include a messaging manager, which is configured to send and receive messages in communication with the reputation development device.

In a further related aspect, the messages can include emails, phone text messages, and automated phone calls.

In a further related aspect, the reputation development server can further include a workflow manager, which stores and processes a set of customized workflows, such that each customized workflow is executed as a dialogue, which includes a sequence of messages, which are sent in communication with the messaging manager; wherein the automated dialogue is associated with a predetermined customized workflow.

In an aspect, a method for reputation development can include: receiving a rating, selecting an optimal workflow, executing a customer dialogue, wherein the customer dialogue is defined by the optimal workflow.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating an online reputation development system, according to an embodiment of the invention.

FIG. 2 is a schematic diagram illustrating a reputation development server, according to an embodiment of the invention.

FIG. 3 is a schematic diagram illustrating a reputation development device, according to an embodiment of the invention.

FIG. 4 is a flowchart illustrating steps that may be followed, in accordance with one embodiment of a method or process of reputation development.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

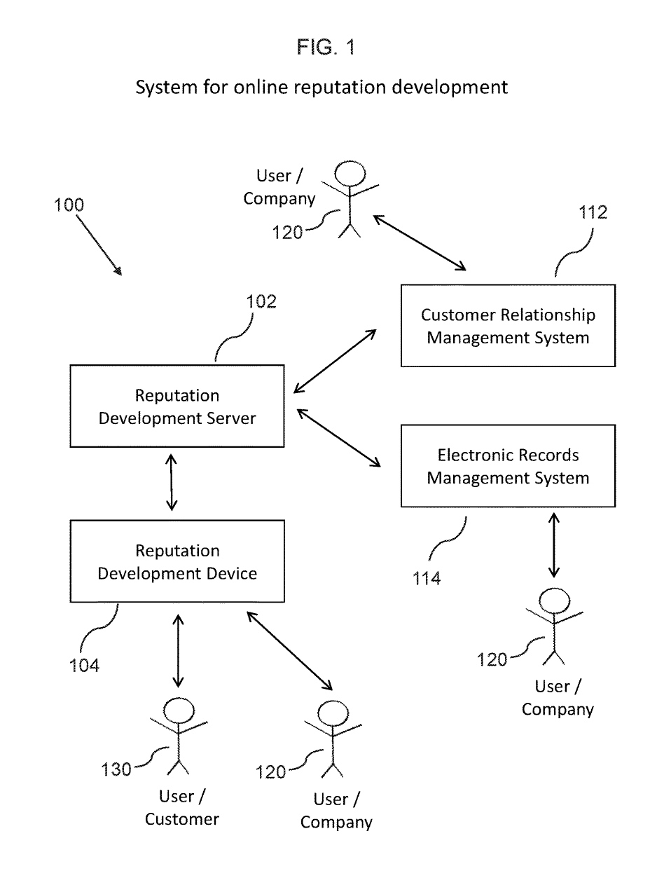

In the following, we describe the structure of an embodiment of a system for online reputation development 100 with reference to FIG. 1, in such manner that like reference numerals refer to like components throughout; a convention that we shall employ for the remainder of this specification.

In an embodiment a system for online reputation development 100 can include:
a) a reputation development server 102; and
b) at least one reputation development device 104;
wherein the reputation development server can be configured to receive a customer review, including a service rating, which has been provided by a customer in relation to services of a company client;
such that the reputation development server can communicate with a reputation development device used by the customer, such that the reputation development server executes an automated dialogue with the customer, via the reputation development device, wherein the dialogue is selected based on the service rating;
whereby an online reputation of the company client can be developed.

In a related embodiment, the system for online reputation development 100 can be offered to company clients as a software-as-a-service solution.

In a related embodiment, a reputation development server 102 can include:
a) A processor 202;
b) A non-transitory memory 204;
c) An input/output component 206;
d) A messaging manager 210, which is configured to send and receive messages in communication with a reputation development device 104, such that the messages can include email, text messages, and automated phone calls;
e) A workflow manager 212, which is configured to store and process a set of customized workflows, based on customized logic, such that each customized workflow can execute a dialogue, which includes a sequence of messages, which are sent in communication with the messaging manager 210;
f) A company database 214, which is configured to store, retrieve, and process a set of companies, such that for each company is stored company information and a set of company users/employees 120; and
g) A customer database 216, which is configured to store, retrieve, and process a set of customers, such that for each customer is stored customer information, including contact information; all connected via
h) A data bus 220.

In a related embodiment, the workflow manager 212, can be configured to store and process workflows that are defined in a workflow scripting language. The workflow scripting language can be XML based, and can include VoiceXML.

In a further related embodiment, the workflow manager 212 can execute a questionnaire script, which can include a message asking customers for their overall satisfaction after receipt of an offering, in the form of a product or service, such as a patient visit, such that a response message can include a customer review, including a service rating.

In a further related embodiment, if a service rating is below a predetermined low rating value, the workflow manager 212 can execute a low rating script, which can include:
a) Sending a low rating message to the customer, wherein the low rating message includes a prepared apology message;
b) Sending a communication offer message with an offer to initiate a communication with a customer service representative 120, wherein the communication can include:
   i. A phone call, between the customer 130 and the customer service representative 120, initiated by a customer service representative 120 or the customer 130;
   ii. a chat conversation between the customer 130 and the customer service representative 120;
such that the low rating script can help a company user 120 take care of the issue and preempts any negative online reviews from a dissatisfied customer user 130.

In a yet further related embodiment, the low rating script can further include that a business rep./company user 120 can be asked to enter his/her actions in a remark field that is associated with customer information stored in the customer database 216, whereby management can see what is being done to address a customer issue.

In a further related embodiment, if a rating is equal to or higher than a predetermined high rating value, the workflow manager 212 can execute a high rating script, which can include:
a) Sending a high rating message to the customer, wherein the high rating message includes a prepared thank you communication/note/message; and
b) Providing a web link to a review site, such that the customer 130 can provide a review of the service provided. The review site can for example be a company page on Yelp.com, Angie's List, or similar review services.

In a related embodiment, the reputation development server 102 can be configured to generate standard reports, such as percent of customers providing rating, by staff, etc. Additionally, the reputation development server 102 can be configured to provide customized reports.

In a related embodiment, a reputation development device 104 can comprise:
a) A processor 302;
b) A non-transitory memory 304;
c) An input/output 306;
d) A messaging controller 310, which is configured to receive, display, store, send and process messages, wherein the messages can include emails, texts, phone calls; and
e) A workflow controller 312, which is configured to display and receive input for a dialogue, which includes a sequence of messages, which are received in communication with the workflow manager 212 of the reputation development server 102; all connected via
f) A data bus 320.

In a related embodiment, a company user 130 can sign up via the reputation development device 104, for example on a website, such that a company profile is created and stored on the reputation development server 102 in the company database 214.

In a related embodiment, customers 130 can sign up via the reputation development device 104, for example on a website, such that a customer user profile is created and stored on the reputation development server 102 in the customer database 216.

In a related embodiment, the system for online reputation development 100 can further include:
a) a customer relationship management system 112;
such that the reputation development server 102 can be configured to receive a customer review, including a service rating, in communication with the customer relationship management system 112.

In a further related embodiment, the reputation development server 102 can be configured to receive and/or send customer information from/to the customer relationship management system 112, in order to reduce manual entry of customer information.

In a yet further related embodiment, customer relationship management system 112 can be extended with ecommerce functionality, such that a back-end of an ecommerce system, such as Amazon.com, can be an example of a customer relationship management system 112.

In a related embodiment, the system for online reputation development 100 can further include:
a) an electronic records management system 114;
such that the reputation development server 102 can be configured to receive a customer review, including a service rating, in communication with the electronic records management system 114.

In a further related embodiment, the reputation development server 102 can be configured to receive and/or send customer information from/to the electronic records management system 114, in order to reduce manual entry of customer information.

In related embodiments, the reputation development device 104 can include configurations as:
a) A web application, executing in a Web browser;
b) A tablet app, executing on a tablet device, such as for example an Android or iOS tablet device;
c) A mobile app, executing on a mobile device, such as for example an Android phone or iPhone, or any wearable mobile device;
d) A desktop application, executing on a personal computer, or similar device; or
e) An embedded application, executing on a processing device, such as for example a smart TV, a game console or other computer device or system.

It shall be understood that an executing instance of an embodiment of the system for online reputation development 100, as shown in FIG. 1, can include a plurality of reputation development devices 104, which are each tied to one or more users 120.

An executing instance of an embodiment of the system for online reputation development 100, as shown in FIG. 1, can similarly include a plurality of reputation development servers 102.

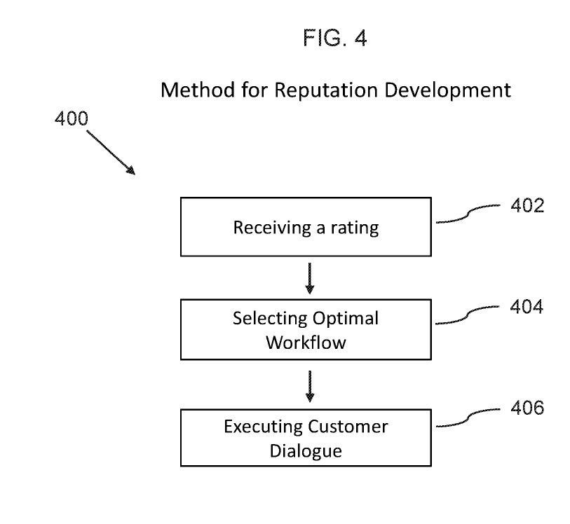

In an embodiment, as illustrated in FIG. 4, a method for reputation development 400, can include:
a) Receiving a rating 402, wherein a rating for an offering is received by a reputation development server 102, wherein the offering is provided by a company, such that the offering is selected from the group consisting of services and products, and the rating is provided by a customer of the company;
b) Selecting an optimal workflow 404, wherein the reputation development server 102 selects an optimal work flow based on the rating; and
c) Executing a dialogue 406, wherein the reputation development server 102 executes a dialogue with the customer, as a sequence of messages to the customer.

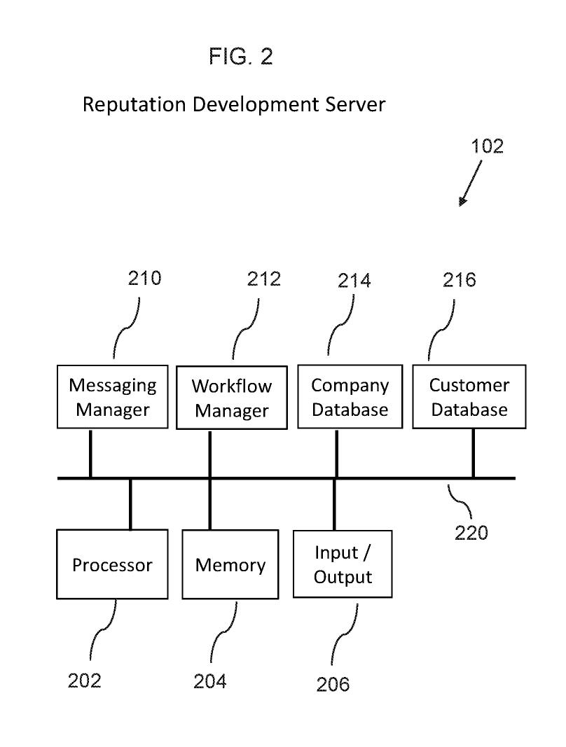

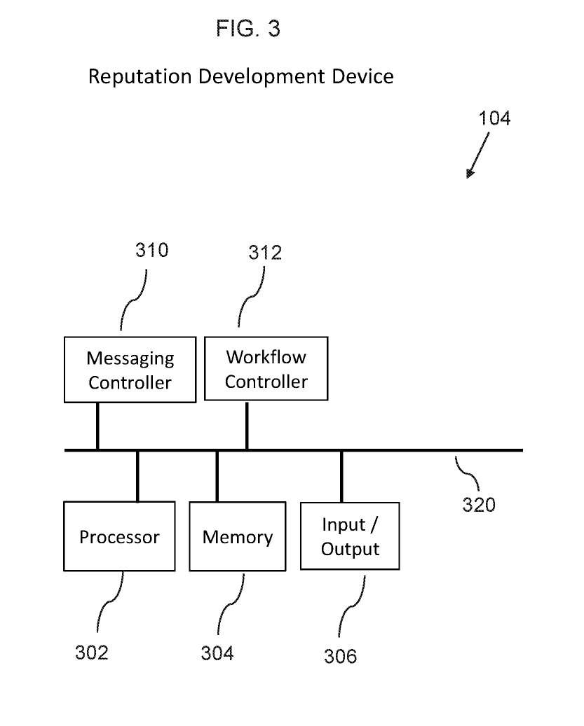

FIGS. 1, 2, 3 and 4 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the system for reputation development 100, including the reputation development server 102, and the reputation development device 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the reputation development server 102 and the reputation development device 104 are to be interpreted in the most general manner.

For example, the processors 202 302 can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the reputation development server 102 and the reputation development device 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the reputation development device 104 communicates with the reputation development server 102 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the reputation development server 102, device 104, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the reputation development server 102 and the reputation development device 104. The components of the reputation development server 102 can be distributed over a plurality of physical, logical, or virtual servers. Parts or all of the components of the reputation development device 104 can be configured to operate in the reputation development server 102, whereby the reputation development device 104 for example can function as a thin client, performing only graphical user interface presentation and input/output functions. Alternatively, parts or all of the components of the reputation development server 102 can be configured to operate in the reputation development device 104. Similarly, parts or all of the components of the customer relationship management system 112 and/or the electronic records management system 114 can be configured to operate in the reputation development server 102.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention . . . .

What is claimed is:

1. A system for online reputation development, comprising:
a) a reputation development server; and
b) at least one reputation development device;
wherein the reputation development server is configured to receive a customer review, including a service rating, which is provided by a customer in relation to an offering provided by a company;
such that the reputation development server is configured to communicate with the at least one reputation development device, which is used by the customer;
such that the reputation development server is configured to execute an automated dialogue with the customer, via the at least one reputation development device, wherein the automated dialogue is selected based on the service rating;
whereby an online reputation of the company client can be developed.

2. The system for online reputation development of claim 1, wherein the reputation development server further comprises:
a) a server processor;
b) a server non-transitory memory;
c) a server input/output component; and
d) a messaging manager, which is configured to send and receive messages in communication with the reputation development device; all connected via
e) a server data bus.

3. The system for online reputation development of claim 2, wherein the messages include emails, phone text messages, and automated phone calls.

4. The system for online reputation development of claim 2, wherein the reputation development server further comprises:
a workflow manager, which is configured to store and process a set of customized workflows, such that each customized workflow executes a dialogue, which includes a sequence of messages, which are sent in communication with the messaging manager;
wherein the automated dialogue is associated with a predetermined customized workflow.

5. The system for online reputation development of claim 4, wherein the service rating is below a predetermined low rating value, such that the workflow manager executes the automated dialogue based on a low rating workflow, wherein the low rating workflow is configured to send a low rating message to the customer, wherein the low rating message includes a predetermined apology.

6. The system for online reputation development of claim 5, wherein the low rating workflow is further configured to send the customer a communication offer message with an offer to initiate a communication with a customer service representative.

7. The system for online reputation development of claim 2, wherein the rating is equal to or higher than a predetermined high rating value, such that the workflow manager executes the automated dialogue based on a high rating workflow, wherein the high rating workflow is configured to send a high rating message to the customer, wherein the high rating message includes a predetermined thank you communication.

8. The system for online reputation development of claim 7, wherein the high rating workflow is further configured to send the customer a web link to a review site, such that the customer can provide a review of the offering.

9. The system for online reputation development of claim 4, wherein the set of customized workflows are defined in a workflow scripting language.

10. The system for online reputation development of claim 9, wherein the workflow scripting language is an XML language.

11. The system for online reputation development of claim 2, wherein the reputation development server further comprises:
a company database; which is configured to store, edit, retrieve, and process a set of companies, such that for each company is stored company information and a set of company users.

12. The system for online reputation development of claim 2, wherein the reputation development server further comprises:
a customer database; which is configured to store, retrieve, and process a set of customers, such that for each customer is stored customer information, including contact information.

13. The system for online reputation development of claim 1, wherein the reputation development device further comprises:
a) a processor;
b) a non-transitory memory;
c) an input/output; and
d) a messaging controller, which is configured to receive, edit, display, store, send, and process messages in communication with the reputation development server; all connected via
e) a data bus.

14. The system for online reputation development of claim 4, wherein the reputation development device further comprises:
a) a device processor;
b) a device non-transitory memory;
c) a device input/output;
d) a messaging controller, which is configured to receive, edit, display, store, send, and process messages; and
e) a workflow controller, which is configured to display and receive input for a dialogue, which includes a sequence of messages, which are received in communication with the workflow manager of the reputation development server; all connected via
f) a device data bus.

15. The system for online reputation development of claim 1, further comprising:
a customer relationship management system;
such that the reputation development server is configured to receive the customer review, including the service rating, in communication with the customer relationship management system.

16. The system for online reputation development of claim 1, further comprising:
an electronic records management system;
such that the reputation development server is configured to receive the customer review, including the service rating, in communication with the electronic records management system.

17. A method for reputation development, comprising:
a) receiving a rating, wherein a rating for an offering is received by a reputation development server, wherein the offering is provided by a company, such that the offering is selected from the group consisting of services and products, and the rating is provided by a customer of the company;
b) selecting an optimal workflow, wherein the reputation development server selects an optimal work flow, wherein the optimal workflow is selected from a set of predetermined workflows, wherein the selection is based on the rating; and
c) executing a customer dialogue, wherein the reputation development server executes an optimal dialogue with the customer, such that the optimal dialogue is a sequence of messages, wherein the optimal dialogue is defined by the optimal workflow.

18. The method for reputation development of claim 17, wherein the messages include emails, phone text messages, and automated phone calls.

19. The method for reputation development of claim 17, wherein the set of predetermined workflows are defined in a workflow scripting language.

20. The method for reputation development of claim 19, wherein the workflow scripting language is an XML language.

21. The method for reputation development of claim 17, wherein the rating is below a predetermined low rating value, such that the optimal work flow is a low rating workflow, comprising:
sending an apology message to the customer, wherein the apology message includes a predetermined apology communication.

22. The method for reputation development of claim 21, wherein the low rating workflow further comprises:
sending the customer a communication offer message with an offer to initiate a communication with a customer service representative.

23. The method for reputation development of claim 17, wherein the rating is equal to or higher than a predetermined high rating value, such that the optimal work flow is a high rating workflow, comprising:
sending a high rating message to the customer, wherein the high rating message includes a predetermined thank you communication.

24. The method for reputation development of claim 23, wherein the high rating workflow further comprises:
sending the customer a web link to a review site, such that the customer can provide a review of the offering.
